(19) United States
(12) Patent Application Publication
(10) Pub. No.: US 2024/0118090 A1
(43) Pub. Date: Apr. 11, 2024

(54) VEHICLE POSITION ESTIMATION DEVICE

(71) Applicant: Mitsubishi Electric Corporation, Tokyo (JP)

(72) Inventors: Kyosuke KONISHI, Tokyo (JP); Masaya ENDO, Tokyo (JP); Toshihiko HASHIBA, Tokyo (JP)

(73) Assignee: Mitsubishi Electric Corporation, Tokyo (JP)

(21) Appl. No.: 18/458,527

(22) Filed: Aug. 30, 2023

(30) Foreign Application Priority Data
Oct. 5, 2022 (JP) 2022-160760

(51) Int. Cl. G01C 21/26

(52) U.S. Cl. CPC G01C 21/26

(57) ABSTRACT

There is provided a vehicle position estimation device, including: a first boundary-line calculation determination unit that calculates a first distance between the vehicle and a boundary line, and determines whether or not the vehicle has crossed the boundary line; a second boundary-line calculation determination unit that calculates a second distance between the vehicle and the boundary line, and determines whether or not the vehicle has crossed the boundary line; a traveling lane matching unit that adjusts at least one of the first and second distances for matching, based on whether or not the vehicle has crossed the boundary line, determined by the first boundary-line calculation determination unit and the second boundary-line calculation determination unit; and a position estimation unit that estimates a position of the vehicle, based on the first or second distance adjusted by the traveling lane matching unit.

### TECHNICAL FIELD

The present application relates to a vehicle position estimation device.

### BACKGROUND ART

During travel of a vehicle on a road, it is important to estimate the accurate position of the vehicle. Heretofore, a technique that estimates the position of the vehicle on the basis of observed data of multiple detection means has been known. Here, although the detection means may be sensors that are mounted on the vehicle and detect an external environment thereof, they may be sensors that are provided outside the vehicle and detect motion-related elements such as a position, a speed, etc. of the vehicle.

There is disclosed a technique of accurately estimating the position of the vehicle in such a manner that a position of the vehicle is calculated using a Global Navigation Satellite System (GNSS); then the position of the vehicle is identified on a map and a distance between the vehicle and its nearby object is calculated; in addition, a distance between the vehicle and the nearby object is detected using an on-vehicle sensor; and thereafter, the position of the vehicle is estimated so that its deviations from the distances calculated by such two different means are minimized (for example, Patent Document 1).

### CITATION LIST

### Patent Document

Patent Document 1: Japanese Patent No. 6203982

The technique disclosed in Patent Document 1 is based on the assumption that the nearby objects observed by the respective detection means are the same object. If multiple objects having similar shapes and colors are present around the vehicle, a case is conceivable where the respective means detect distances from such mutually different objects to the vehicle. In that case, when the position of the vehicle is adjusted so that its deviations from the calculated two different distances are minimized, a case may arise where the accuracy of vehicle position estimation is degraded.

This problem occurs, particularly in cases where a distance to a boundary line on the road during travel is used to estimate the position of the vehicle. This problem emerges remarkably when the vehicle makes a movement of crossing the boundary line in order to change the lane (traveling lane). This is because the shapes and colors of respective boundary lines are similar to each other and thus, at the time of lane change of the vehicle, it may be highly likely that confusion will occur between “boundary lines on right and left sides viewed from the vehicle” acquired by the respective detection means.

### SUMMARY

This application has been made to solve the problem as described above. An object thereof is to provide a vehicle position estimation device which, at the time of estimating the position of a vehicle by using a distance from the vehicle to a boundary line, can accurately estimate the current position of the vehicle by restricting the accuracy of vehicle position estimation from being degraded, even when the vehicle makes a lane change.

### Solution to Problem

A vehicle position estimation device according to this application comprises:
a first boundary-line calculation determination unit that detects a position of a boundary line on a road to thereby calculate a first distance between a vehicle and the boundary line, and that determines whether or not the vehicle has crossed the boundary line, on a basis of the first distance;
a second boundary-line calculation determination unit that detects a position of the boundary line on the road to thereby calculate a second distance between the vehicle and the boundary line, and that determines whether or not the vehicle has crossed the boundary line, on a basis of the second distance;
a traveling lane matching unit that adjusts at least one of the first distance and the second distance for matching, on a basis of: whether or not the vehicle has crossed the boundary line, determined by the first boundary-line calculation determination unit; and whether or not the vehicle has crossed the boundary line, determined by the second boundary-line calculation determination unit; and
a position estimation unit that estimates a position of the vehicle on a basis of the first distance or the second distance adjusted for matching by the traveling lane matching unit.

### Advantageous Effects

By the vehicle position estimation device according to this application, at the time of estimating the position of the vehicle by using the distance from the vehicle to the boundary line, it is possible to accurately estimate the current position of the vehicle by restricting the accuracy of vehicle position estimation from being degraded, even when the vehicle makes a lane change.

### BRIEF DESCRIPTION OF DRAWINGS

FIG. 1 is a configuration diagram of a vehicle position estimation device according to Embodiment 1.

FIG. 2 is a hardware configuration diagram of the vehicle position estimation device according to Embodiment 1.

FIG. 3 is a diagram showing a lane change of a vehicle, according to Embodiment 1.

FIG. 4 is a graph showing a distance to a boundary line during a lane change of the vehicle, according to Embodiment 1.

FIG. 5 is a set of graphs showing distances to a boundary line according to a first sensor and a second sensor during a lane change of the vehicle, according to Embodiment 1.

FIG. 6 is a set of graphs showing matching between the distances to the boundary line according to the first sensor and the second sensor during the lane change of the vehicle, according to Embodiment 1.

FIG. 7 is a first flowchart showing processing by the vehicle position estimation device according to Embodiment 1.

FIG. 8 is a second flowchart showing processing by the vehicle position estimation device according to Embodiment 1.

FIG. 9 is a set of graphs showing distances to boundary lines according to a first sensor and a second sensor during a lane change of a vehicle, according to Embodiment 2.

FIG. 10 is a first set of graphs showing matching between the distances to the boundary lines according to the first sensor and the second sensor during the lane change of the vehicle, according to Embodiment 2.

FIG. 11 is a second set of graphs showing matching between the distances to the boundary lines according to the first sensor and the second sensor during the lane change of the vehicle, according to Embodiment 2.

FIG. 12 is a first flowchart showing processing by a vehicle position estimation device according to Embodiment 2.

FIG. 13 is a second flowchart showing processing by the vehicle position estimation device according to Embodiment 2.

FIG. 14 is a configuration diagram of a vehicle position estimation device according to Embodiment 3.

FIG. 15 a first flowchart showing processing by the vehicle position estimation device according to Embodiment 3.

FIG. 16 is a configuration diagram of a vehicle position estimation device according to Embodiment 4.

FIG. 17 is a flowchart showing processing by the vehicle position estimation device according to Embodiment 4.

### DESCRIPTION OF EMBODIMENTS

### 1. Embodiment 1

<Configuration of Vehicle Position Estimation Device>

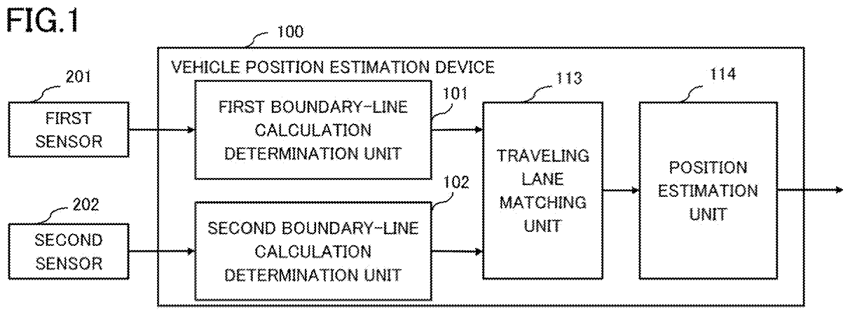

FIG. 1 is a configuration diagram of a vehicle position estimation device 100 according to Embodiment 1. The vehicle position estimation device 100 has a first boundary-line calculation determination unit 101, a second boundary-line calculation determination unit 102, a traveling lane matching unit 113 and a position estimation unit 114. The first boundary-line calculation determination unit 101 is connected to a first sensor 201, and the second boundary-line calculation determination unit 102 is connected to a second sensor 202.

The first sensor 201 and the second sensor 202 both observe a position of a boundary line on a road on which an object vehicle 1 travels, and transfer signals related to their observed data to the first boundary-line calculation determination unit 101 and the second boundary-line calculation determination unit 102, respectively. The first sensor and the second sensor each output the observed data that indicates a relative positional relationship between the object vehicle 1 and the boundary line. When there are multiple boundary lines on the right or left side of the object vehicle 1, the first sensor 201 and the second sensor 202 may each observe the positions of these boundary lines.

Here, each of the first sensor 201 and the second sensor 202 may be of any type so long as it has a function of acquiring a relative positional relationship between the object vehicle 1 and the boundary line. The first sensor 201 and the second sensor 202 may be sensor devices each provided with a function of acquiring a relative positional relationship between the object vehicle 1 and the boundary line, on the basis of a visible-light image or an image of light other than visible light acquired by an imaging element. Further, for example, they may be sensor devices each provided with a function of radiating electromagnetic waves in a specified frequency range and then receiving reflected electromagnetic waves from an object, to thereby acquire a relative positional relationship between the object vehicle 1 and the boundary line. Further, for example, they may be sensors each provided with a function of combining: the latitude and longitude information of the object vehicle 1 calculated on the basis of signals received from satellites; continuous relative-movement information calculated through measurement of the movement distance, the movement speed and the acceleration rate of the object vehicle 1; and map information, together, to thereby acquire a relative positional relationship between the object vehicle 1 and the boundary line. In this case, such a positional relationship between the object vehicle 1 and the boundary line may be used as input information, that has been calculated from information of satellite signals and information from a wheel rotation sensor, an acceleration sensor, a rotational acceleration sensor, map data, etc. Further, the first sensor 201 and the second sensor 202 may be sensor devices of mutually different types, or may be sensors that are of the same type but are mutually different in characteristic such as measurement sensitivity or the like.

The vehicle position estimation device 100 outputs an estimated position of the object vehicle 1. Here, the estimated position of the object vehicle 1 may be defined as a relative position of the object vehicle 1 with respect to the right or left boundary line of a lane (traveling lane) on which the object vehicle 1 is traveling. Further, a value indicative of a distance with reference to the position of the object vehicle 1 and up to a boundary line, may be used as information that defines the position of the object vehicle 1 in the lane. Hereinafter, with respect to the estimated position of the object vehicle 1, such cases will be described as examples where a value of the relative distance between the vehicle and a right or left boundary line in a coordinate system using the object vehicle 1 as the origin point is regarded as an estimated position of the object vehicle 1.

The estimated position of the object vehicle 1 outputted by the vehicle position estimation device 100 may be used as an input to a display device and a vehicle control device. By use of the observed data of the first sensor 201 and the second sensor 202 detected at a time t, the estimated position of the object vehicle 1 at the time t can be outputted in real time.

The first boundary-line calculation determination unit 101 uses, as its input, signals related to the observed data from the first sensor 201, to thereby calculate a first distance between the object vehicle 1 and a boundary line. The first boundary-line calculation determination unit 101 determines whether or not the object vehicle 1 has crossed the boundary line, on the basis of the thus-calculated first distance. The first boundary-line calculation determination unit 101 outputs the determination result, together with the calculated first distance, to the traveling lane matching unit 113.

The second boundary-line calculation determination unit 102 uses, as its input, signals related to the observed data from the second sensor 202, to thereby calculate a second distance between the object vehicle 1 and the boundary line. The second boundary-line calculation determination unit 102 determines whether or not the object vehicle 1 has crossed the boundary line, on the basis of the thus-calculated second distance. The second boundary-line calculation determination unit 102 outputs the determination result, together with the calculated second distance, to the traveling lane matching unit 113.

The traveling lane matching unit 113 receives, as its inputs, the outputs from the first boundary-line calculation determination unit 101 and the second boundary-line calculation determination unit 102. There are cases where the traveling lane matching unit 113 transfers the first distance calculated by the first boundary-line calculation determination unit 101 and the second distance calculated by the second boundary-line calculation determination unit 102 as they are without being adjusted for matching, to the position estimation unit 114. Further, there are cases where the traveling lane matching unit 113 transfers the first distance and the second distance after adjusting one or both of them for matching, to the position estimation unit 114.

The traveling lane matching unit 113 makes a determination about matching of the first distance or the second distance, on the basis of: whether or not the object vehicle 1 has crossed the boundary line, determined by the first boundary-line calculation determination unit 101; and whether or not the object vehicle 1 has crossed the boundary line, determined by the second boundary-line calculation determination unit 102. The position estimation unit 114 uses, as its input, the output from the traveling lane matching unit 113, to thereby estimate and output the position of the object vehicle 1 based on the observed data of the first sensor 201 and the second sensor 202.

<Hardware Configuration of Vehicle Position Estimation Device>

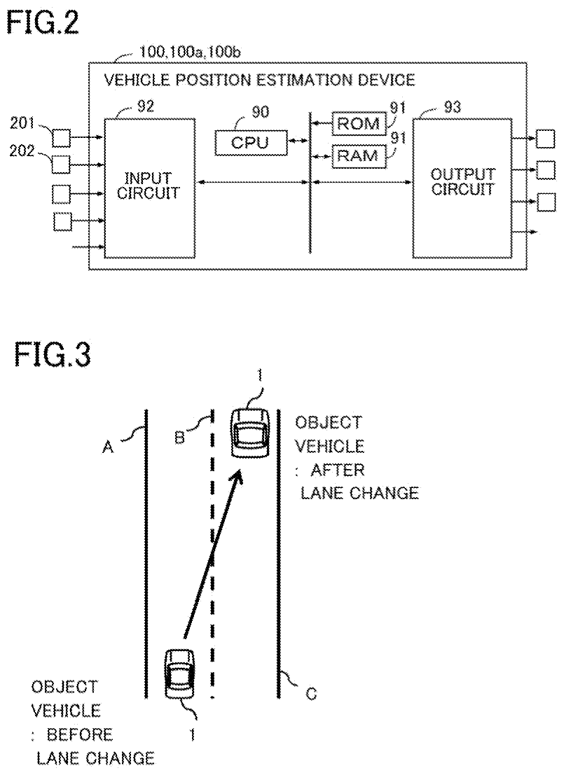

FIG. 2 is a hardware configuration diagram of the vehicle position estimation device 100. Although FIG. 2 may be applied also to vehicle position estimation devices 100a, 100b to be described later, description is herein made about the vehicle position estimation device 100 as a representative. In this Embodiment, the vehicle position estimation device 100 is an electronic control device for estimating the position of a vehicle by using a distance from the vehicle to a boundary line. The respective functions of the vehicle position estimation device 100 are implemented by a processing circuit included in the vehicle position estimation device 100. Specifically, the vehicle position estimation device 100 includes as the processing circuit: an arithmetic processing device 90 (computer) such as a CPU (Central Processing Unit) or the like; storage devices 91 that perform data transactions with the arithmetic processing device 90; an input circuit 92 that inputs external signals to the arithmetic processing device 90; an output circuit 93 that externally outputs signals from the arithmetic processing device 90; and the like. The respective pieces of hardware, such as the arithmetic processing device 90, the storage devices 91, the input circuit 92, the output circuit 93, etc. are connected to each other by way of a wired network such as a bus, or a wireless network.

As the arithmetic processing device 90, there may be included an ASIC (Application Specific Integrated Circuit), an IC (Integrated Circuit), a DSP (Digital Signal Processor), a GPU (Graphics Processing Unit), an FPGA (Field Programmable Gate Array), any one of a variety of logic circuits, any one of a variety of signal processing circuits, or the like. Further, multiple arithmetic processing devices 90 of the same type or different types may be included so that the respective parts of processing are executed in a shared manner. As the storage devices 91, there are included a RAM (Random Access Memory) that is configured to allow reading and writing of data by the arithmetic processing device 90, a ROM (Read Only Memory) that is configured to allow reading of data by the arithmetic processing device 90, and the like. As the storage device 91, a non-volatile or volatile semiconductor memory, such as a flash memory, an SSD (Solid State Drive), an EPROM, an EEPROM or the like; a magnetic disc; a flexible disc; an optical disc; a compact disc; a mini disc; a DVD; or the like, may be used. The input circuit 92 includes A-D converters, a communication circuit, etc. to which output signals of a variety of sensors and switches including the first sensor 201 and the second sensor 202, and a communication line, are connected, and which serve to input these output signals of the sensors and switches, and communication information, to the arithmetic processing device 90. The output circuit 93 includes a driver circuit, a communication circuit, etc. which serve to output control signals from the arithmetic processing device 90. The interfaces of the input circuit 92 and the output circuit 93 may be those based on the specification of CAN (Control Area Network) (Registered Trademark), Ethernet (Registered Trademark), USB (Universal Serial Bus) (Registered Trademark), DVI (Digital Visual Interface) (Registered Trademark), HDMI (High-Definition Multimedia Interface) (Registered Trademark) or the like.

The respective functions that the vehicle position estimation device 100 includes, are implemented in such a manner that the arithmetic processing device 90 executes software (programs) stored in the storage device 91 such as the ROM or the like, to thereby cooperate with the other hardware in the vehicle position estimation device 100, such as the other storage device 91, the input circuit 92, the output circuit 93, etc. Note that the set data of threshold values, determinative values, etc. to be used by the vehicle position estimation device 100 is stored, as a part of the software (programs), in the storage device 91 such as the ROM or the like. Although each of the functions that the vehicle position estimation device 100 has, may be established by a software module, it may be established by a combination of software and hardware.

<Lane Change of Vehicle>

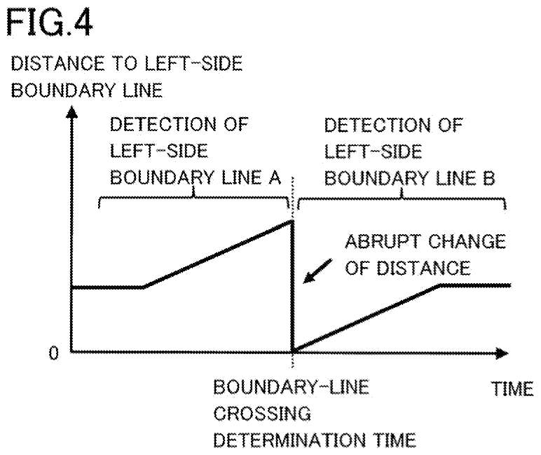

FIG. 3 is a diagram showing a lane change of the vehicle 1, according to Embodiment 1. FIG. 4 is a graph showing a distance to a boundary line during the lane change of the vehicle 1, according to Embodiment 1. As shown in FIG. 3, a case will be described where the object vehicle 1 changes the traveling lane from the left lane to the right lane. Here, the description for that case will be made using, as a value indicative of the position of the object vehicle 1 in the lane, a distance to the nearest lane on the left side of the object vehicle 1 (hereinafter, referred to as “a distance to a left-side boundary line”). The distance to the left-side boundary line of the object vehicle 1 varies as in the graph shown in FIG. 4.

The ordinate of the graph shown in FIG. 4 represents a distance to the left-side boundary line. With respect to the distance to the left-side boundary line, a distance in the leftward direction with reference to the center line of the object vehicle 1 and relative to the traveling direction of the object vehicle 1, is regarded as positive. In the case shown in FIG. 3, because of the traveling lane change, the line nearest and left next to the object vehicle 1, is changed from a boundary line A to a boundary line B. Thus, as shown in FIG. 4, the distance to the left-side boundary line varies abruptly and non-continuously at a certain time (boundary-line crossing determination time).

As shown in FIG. 3, the value indicative of the position of the object vehicle 1 may also be indicated by use of a distance to the nearest lane on the right side of the object vehicle 1 (hereinafter, referred to as “a distance to a right-side boundary line”). With respect also to the distance to the right-side boundary line, because of the traveling lane change, the line is changed from the boundary line B to a boundary line C. Accordingly, the distance to the right-side boundary line also varies abruptly at the timing at which the object vehicle 1 crosses the boundary line.

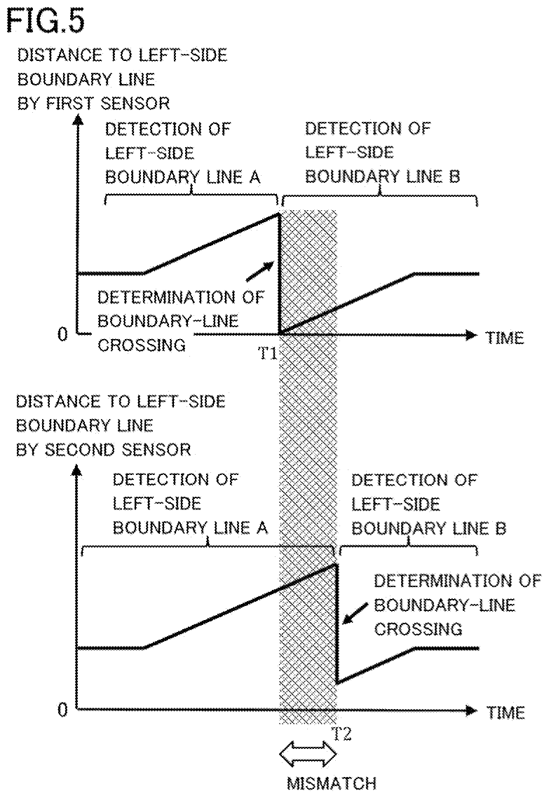

FIG. 5 is a set of graphs showing distances to the boundary line according to the first sensor 201 and the second sensor 202 during the lane change of the vehicle 1, according to Embodiment 1. In FIG. 5, with respect to the case of the traveling lane change shown in FIG. 3, exemplary observed data is shown that is related to distances to the left-side boundary line and outputted from the first sensor 201 and the second sensor 202. As aforementioned, the distance to the left-side boundary line observed by each of the first sensor 201 and the second sensor 202 shows a non-continuous change at a crossing time T1 or a crossing time T2.

The crossing time T1 at which the non-continuous change emerges in the observed data of the first sensor 201 and the crossing time T2 at which the non-continuous change emerges in the observed data of the second sensor 202, do not necessarily coincide with each other. This is thought to be due to a difference between these sensors in mounted position or observation method, or a sensor-to-sensor error, or the like.

For example, the first sensor 201 is a sensor that detects a boundary line on the basis of an image acquired by an imaging element, so that a time at which the object vehicle 1 is determined to make a lane change on the basis of the field of the image, corresponds to the crossing time T1. Further, for example, the second sensor 202 is a sensor that calculates the positions of the boundary line and the object vehicle 1 through position determination with the satellites and collation with a map, so that the latitude and longitude of the object vehicle 1 is determined as its position and a time at which this position crosses a boundary line on the map, corresponds to the crossing time T2. In the mentioned case, the first sensor 201 and the second sensor 202 differ significantly from each other in measurement method, so that the crossing time T1 and the crossing time T2 do not necessarily coincide with each other. Further, even if the first sensor 201 and the second sensor 202 have ever been pre-calibrated so that the crossing time T1 and the crossing time T2 coincide with each other, when an error included in each of the sensors may vary by time, it can't be said that the crossing time T1 and the crossing time T2 constantly coincide with each other.

In FIG. 5, a mismatch occurs in an interval between the crossing time T1 and the crossing time T2 because the first sensor 201 and the second sensor 202 indicate the position of the object vehicle 1 individually by using distances to the different boundary lines. Because of the mismatch, a sensor-to-sensor difference in distance to the boundary line increases significantly.

According to the case of FIG. 5, description will be further given as follows. In the time range between the crossing time T1 and the crossing time T2, the first sensor 201 recognizes the left-side boundary line after the lane change of the object vehicle 1 (boundary line B) as the nearest left-side boundary line, whereas the second sensor 202 recognizes the left-side boundary line before the lane change of the object vehicle 1 (boundary line A) as the nearest left-side boundary line. Accordingly, in the interval between the crossing time T1 and the crossing time T2, the difference increases significantly between the distances to the left-side boundary line according to the first sensor 201 and the second sensor 202. Thus, degradation occurs in the accuracy of position estimation for the object vehicle 1 based on information from these sensors.

<Matching of Distance>

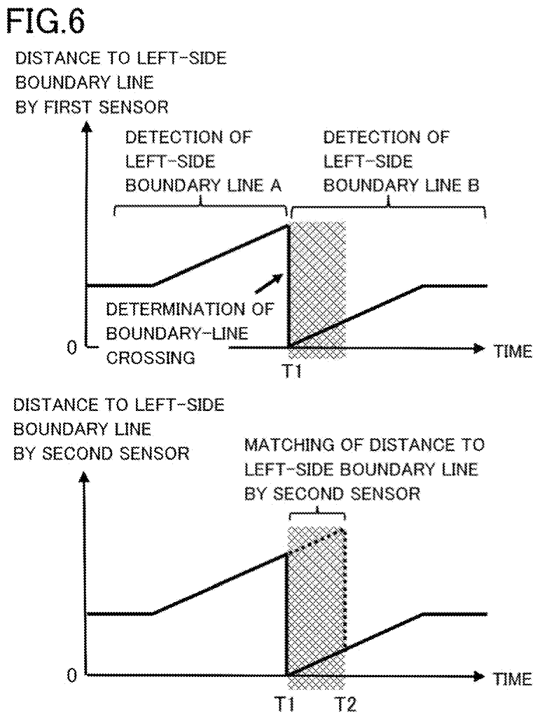

FIG. 6 is a set of graphs showing matching between distances to the boundary line according to the first sensor 201 and the second sensor 202 during the lane change of the vehicle 1, according to Embodiment 1. “Matching” is to make adjustment so as to avoid a trouble, namely, it means to adjust the value to that assumed to be correct. Here, the traveling lane matching unit 113 performs matching between the distances to the left-side boundary line. As shown in FIG. 6, it performs processing so that the times according to the first sensor 201 and the second sensor 202 at which the distance to the left-side boundary line varies abruptly, are matched therebetween.

Specifically, following processing is performed. First, on the basis of the input from the first sensor 201, the first boundary-line calculation determination unit 101 determines that the object vehicle 1 has crossed the boundary line at the crossing time T1. On the basis of that determination, the traveling lane matching unit 113 assumes that an inconsistency occurs between the traveling lanes on which the object vehicle 1 is traveling, according to the first sensor 201 and the second sensor 202. Then, it performs conversion of the traveling lane according to the observed data of the second sensor 202 so that it is matched with the traveling lane according to the observed data of the first sensor 201. Namely, distances to the left-side boundary line according to the second sensor 202 are substituted with distances to the left-side boundary line according to the first sensor 201. The traveling lane matching unit 113 outputs to the position estimation unit 114, the distance to the left-side boundary line according to the first sensor 201 and the distance to the left-side boundary line according to the second sensor 202 after being adjusted for matching.

Thereafter, on the basis of the inputted observed data of the second sensor 202, the second boundary-line calculation determination unit 102 determines that the object vehicle 1 has crossed the boundary line at the time T2. On the basis of that determination, the traveling lane matching unit 113 assumes that the difference between the traveling lanes according to the first sensor 201 and the second sensor 202 has been resolved. Then, it terminates matching processing of the distance to the left-side boundary line according to the sensor 202, that was performed in the interval between the crossing time T1 and the crossing time T2.

According to such processing, as shown in FIG. 6, the respective observed data of these sensors to be inputted to the position estimation unit 114 are matched with each other so that, totally, the distances to the boundary line A both change abruptly to the distances to the boundary line B at the same crossing time T1.

<Processing by Vehicle Position Estimation Device>

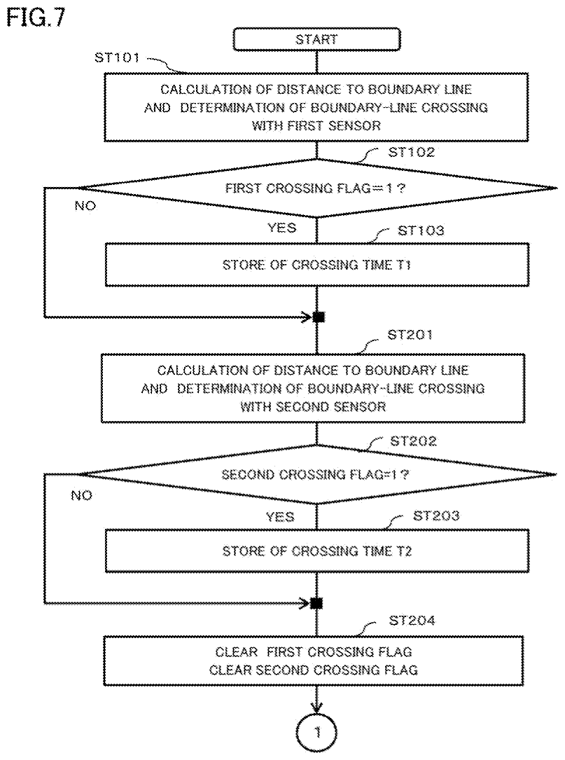

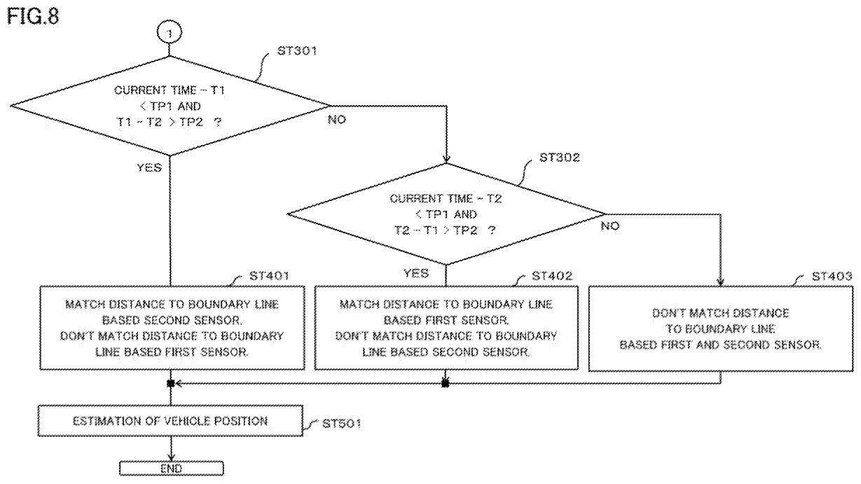

FIG. 7 is a first flowchart showing processing by the vehicle position estimation device 100 according to Embodiment 1. FIG. 8 is a second flowchart showing processing by the vehicle position estimation device 100, which shows steps subsequent to FIG. 7.

FIG. 7 and FIG. 8 are flowcharts in which shown are operations of the first boundary-line calculation determination unit 101, the second boundary-line calculation determination unit 102, the traveling lane matching unit 113 and the position estimation unit 114, from when the signals of the observed data at the current time are inputted from the respective sensors until when the estimated position of the object vehicle 1 at the current time is outputted. The processing of the flowchart of FIG. 7 is executed every fixed period of time (for example, every 10 ms). It is allowed that the processing of the flowchart of FIG. 7 is not executed every fixed period of time but executed in response to an occurrence of an event, such as, at every time the vehicle travels a fixed distance, at every time the sensor acquires new information, or at the time an instruction is given from the outside.

After the processing of the flowchart of FIG. 7 is started, in Step ST101, the first boundary-line calculation determination unit 101 calculates the first distance between the object vehicle 1 and the boundary line on the basis of the observed data of the first sensor 201. Then, it determines whether or not the object vehicle 1 at the current time has crossed the boundary line, on the basis of the thus-calculated first distance. When it determines that the vehicle has crossed the boundary line, a first crossing flag is set.

This determination of boundary-line crossing may be made using, for example, variation in the value of the distance between the boundary line and the object vehicle 1. The occurrence of the boundary-line crossing may be determined when the first distance varies more than a predetermined crossing determination distance within a predetermined crossing determination time.

In another manner, a distance between the boundary line and the object vehicle 1 according to the observed data of the first sensor 201 at a time at which that data is last valid (a past time closest to the current time), is compared with a distance between the boundary line and the object vehicle 1 according to the observe data at the current time at which that data is valid. If a difference from the comparison result exceeds a fixed value, it is determined that the vehicle has crossed the boundary line. Here, “the observed data is valid” can be defined as a situation in which the reliability of the observed data of the first sensor 201 is a specified value or more. For example, when the first sensor 201 is a sensor of such a type that measures a distance between a boundary line and the object vehicle 1 by using an imaging element, if the boundary line is blurred or the noise from the imaging element is large, it may be assumed that the reliability of the observed data is low and thus the observed data is invalid. In this manner, by the comparison between the last-valid observed data and the valid current observed data, it is possible to determine that the object vehicle 1 has crossed the boundary line. This makes it possible to avoid a situation where erroneous boundary-line crossing determination is made, even when the accuracy of the observed data is reduced temporarily.

Further, other than the determination method exemplified above, such a method may be employed in which boundary-line crossing is determined using observed data special to the first sensor 201. For example, when the first sensor 201 is a sensor of such a type that calculates the distance between the boundary line and the object vehicle 1 by using collation between a result of position determination by the satellites and a map, whether the traveling lane is changed may be judged.

This makes it possible to make the determination of the boundary-line crossing according to whether or not the lane on which the object vehicle 1 has traveled at a time at which that data is last valid, is the same as the lane on the map on which the object vehicle 1 is currently traveling. When the sensor is of this type, whether “the observed data is valid” or not can be determined depending on the reliability indicative of the quality of the position-determination signals of the satellites. According also to this exemplary determination method, by the comparison between the last-valid observed data and the current observed data, it is possible to avoid a situation where erroneous crossing determination is made, even when the accuracy of the observed data is reduced temporarily.

Further, in the above determination, an angle of the traveling direction of the object vehicle 1 with respect to the boundary line may be used in combination. For example, the determination may be made in such a manner that as the traveling direction angle with respect to the boundary line becomes closer to the right angle, the conditions for the boundary-line crossing determination are relaxed.

Further, in each determination method described above, the observed data that is related to both of the nearest left-side boundary line and the nearest right-side boundary line, or that is related to only one of them, may be used. For example, when the crossing determination is made on the nearest right-side boundary line on the basis of the observed data related to the nearest right-side boundary line, the observed data related to the nearest left-side boundary is not necessarily used. Note that, in this step, whether the vehicle has crossed the right-side boundary line or the left-side boundary line is determined additionally.

In Step ST102, in response to the determination result in Step ST101, the first boundary-line calculation determination unit 101 makes conditional branching of processing. In Step ST102, whether the first crossing (determination) flag is being set or not is determined. If the first crossing (determination) flag is not being set (judgement is NO), the flow moves to Step ST201.

In Step ST102, if it is determined that the first crossing (determination) flag is being set (judgement is YES), the flow moves to Step ST103. In Step ST103, the first boundary-line calculation determination unit 101 stores the crossing time T1 of the object vehicle 1 determined to have crossed the boundary line on the basis of the first distance calculated using signals from the first sensor 201. Note that the crossing time T1 is given as a value that is kept without being erased even after the completion of the entire processing of FIG. 7 and FIG. 8. Further, an observation start time of the first sensor 201 is set as the initial value of the crossing time T1.

In Step ST201, the second boundary-line calculation determination unit 102 calculates the second distance between the object vehicle 1 and the boundary line on the basis of the observed data of the second sensor 202. Then, it determines whether or not the object vehicle 1 at the current time has crossed the boundary line, on the basis of the thus-calculated second distance. When it determines that the vehicle has crossed the boundary line, a second crossing flag is set.

Like in Step ST101, the determination of boundary-line crossing in Step ST201 may also be made using, for example, variation in the value of the distance between the boundary line and the object vehicle 1. Further, like in Step ST101, the determination of boundary-line crossing may be made by the comparison of the latest observed data that is valid. Further, like in Step ST101, the determination of boundary-line crossing may be made using observed data special to the second sensor 202. Note that, in this step, whether the vehicle has crossed the right-side boundary line or the left-side boundary line is determined additionally.

In Step ST202, in response to the determination result in Step ST201, the second boundary-line calculation determination unit 102 makes conditional branching of processing. In Step ST202, whether the second crossing (determination) flag is being set or not is determined. If the second crossing (determination) flag is not being set (judgement is NO), the flow moves to Step ST204.

In Step ST202, if it is determined that the second crossing (determination) flag is being set (judgement is YES), the flow moves to Step ST203. In Step ST203, the second boundary-line calculation determination unit 102 stores the crossing time T2 of the object vehicle 1 determined to have crossed the boundary line on the basis of the second distance calculated using signals from the second sensor 202. Note that the crossing time T2 is given as a value that is kept without being erased even after the completion of the entire processing of FIG. 7 and FIG. 8. Further, an observation start time of the second sensor 202 is set as the initial value of the crossing time T2.

In Step ST204, the first crossing (determination) flag and the second crossing (determination) flag are cleared. Then, the flow moves to Step ST301 in FIG. 8.

In Step ST301 in FIG. 8, the traveling lane matching unit 113 determines whether or not the first boundary-line calculation determination unit 101 has made the determination of boundary-line crossing, at a time near the current time, earlier than the second boundary-line calculation determination unit 102. Specifically, this determination is deemed true if the difference between the current time and the crossing time T1 is less than a matching duration time TP1 (meaning that the crossing time T1 has been updated recently) and the value resulting from subtracting the crossing time T2 from the crossing time T1 is more than a matching prohibition time TP2 (meaning that, unlike the crossing time T1, the crossing time T2 has not been updated from the matching prohibition time TP2 before).

Here, the matching duration time TP1 and the matching prohibition time TP2 are parameter values related to preset periods of time. The matching duration time TP1 is a relatively short period of time from the start of matching processing to the completion of matching. The matching prohibition time TP2 is a prohibition period of time after matching processing is executed until the start of new matching processing is allowed, which is a long period of time relative to the matching duration time TP1. In this Step ST301, if the determination is true (judgement is YES), the flow moves to Step ST401. In Step ST301, if the determination is false (judgement is NO), the flow moves to Step ST302.

In Step ST302, the traveling lane matching unit 113 determines whether or not the second boundary-line calculation determination unit 102 has made the determination of boundary-line crossing, at a time near the current time, earlier than the first boundary-line calculation determination unit 101. Specifically, this determination is deemed true if the difference between the current time and the crossing time T2 is less than the matching duration time TP1 (meaning that the crossing time T2 has been updated recently) and the value resulting from subtracting the crossing time T1 from the crossing time T2 is more than the matching prohibition time TP2 (meaning that, unlike the crossing time T2, the crossing time T1 has not been updated from the matching prohibition time TP2 before).

In this Step ST302, if the determination is true (judgement is YES), the flow moves to Step ST402. In Step ST302, if the determination is false (judgement is NO), the flow moves to Step ST403.

In Step ST401, the traveling lane matching unit 113 adjusts for matching, the second distance based on the observed data of the second sensor 202, by using the first distance based on the observed data of the first sensor 201. Accordingly, the traveling lane of the object vehicle 1 based on the observed data of the second sensor 202 is adjusted so as to be the same as the traveling lane of the object vehicle 1 based on the observed data of the first sensor 201. The first distance based on the observed data of the first sensor 201 is not adjusted for matching.

Because the matching processing is applied to the second distance based on the observed data of the second sensor 202, the second distance after the crossing time T1 is substituted with the first distance as exemplified in FIG. 6. According to this matching, in the observed data of all of the sensors, the traveling lanes of the object vehicle 1 are uniformized to have the boundary line that the vehicle has crossed at the crossing time T1. Similar matching processing is also applied when the object vehicle 1 is determined to have crossed the left-side boundary line. According to this Step ST401, the second distance adjusted for matching and the first distance not adjusted for matching are transferred to the position estimation unit 114.

In Step ST402, the traveling lane matching unit 113 adjusts for matching, the first distance based on the observed data of the first sensor 201, by using the second distance based on the observed data of the second sensor 202. Accordingly, the traveling lane of the object vehicle 1 based on the observed data of the first sensor 201 is adjusted so as to be the same as the traveling lane of the object vehicle 1 based on the observed data of the second sensor 202. The second distance based on the observed data of the second sensor 202 is not adjusted for matching.

Because the matching processing is applied to the first distance based on the observed data of the first sensor 201, the first distance after the crossing time T2 is substituted with the second distance. According to this matching, in the observed data of all of the sensors, the traveling lanes of the object vehicle 1 are uniformized to have the boundary line that the vehicle has crossed at the crossing time T2. Similar matching processing is also applied when the object vehicle 1 is determined to have crossed the left-side boundary line. According to this Step ST402, the first distance adjusted for matching and the second distance not adjusted for matching are transferred to the position estimation unit 114.

In Step ST403, the traveling lane matching unit 113 executes neither the matching processing of the first distance nor that of the second distance. The first distance that is based on the observed data of the first sensor 201 and not adjusted for matching, and the second distance that is based on the observed data of the second sensor 202 and not adjusted for matching, are transferred to the position estimation unit 114.

In Step ST501, the position estimation unit 114 receives the first distance and the second distance that are based on the observed data of the respective sensors and are each being adjusted or not adjusted for matching in one of Step ST401, Step ST402 and Step ST403. The matching processing in Step ST401 and Step ST402 is applied to the first distance and the second distance to be transferred to the position estimation unit 114. In contrast, the calculation of the first distance and the determination on whether or not the vehicle has crossed the boundary line, to be executed by the first boundary-line calculation determination unit 101, as well as the calculation of the second distance and the determination on whether or not the vehicle has crossed the boundary line, to be executed by the second boundary-line calculation determination unit 102, are continued without being affected by the matching processing.

Using the first distance and the second distance, the position estimation unit 114 calculates the estimated position of the object vehicle 1. For this calculation of the estimated position, an already-existing technique of sensor fusion is employed. For example, such weights each corresponding to the accuracy of each of the sensors may be set to the respective observed data, to thereby determine, using these weights, a weighted average value of the first distance according to the observed data of the first sensor 201 and the second distance according to the observed data of the second sensor 202, as the estimated position of the object vehicle 1. For further example, as disclosed in Patent Document 1, such processing may be performed that estimates the position of the vehicle so that its deviations from the first distance according to the observed data of the first sensor 201 and the second distance according to the observed data of the second sensor 202 become minimum.

By the thus-configured vehicle position estimation device 100 according to Embodiment 1, it is possible to achieve a following effect. In the vehicle position estimation device 100, whether or not the object vehicle 1 has crossed the boundary line is determined on the basis of the distances calculated in the first boundary-line calculation determination unit 101 and the second boundary-line calculation determination unit 102 by using the observed data of the respective sensors. Then, in the traveling lane matching unit 113, on the basis of the determination on whether or not the object vehicle 1 has crossed the boundary line, it is possible to perform matching processing by which the traveling lanes of the object vehicle 1 based on the distances calculated using the observed data of the respective sensors, are uniformized. Thus, the different boundary lines are restricted from being erroneously regarded as the same boundary line by the observed data of the respective sensors. Further, the position estimation unit 114 estimates the position of the object vehicle 1 on the basis of the first distance or the second distance adjusted for matching. Accordingly, there is achieved an effect of restricting the accuracy of position estimation of the object vehicle 1 from being degraded, even when the object vehicle 1 makes a traveling lane change.

In another aspect, in the first boundary-line calculation determination unit 101/the second boundary-line calculation determination unit 102, whether or not the object vehicle 1 has crossed the boundary line is determined by the comparison between the observed data at the time signals inputted from the first sensor 201/the second sensor 202 were last valid, and the valid observed data at the current time. This makes it possible, when the observed data of the first sensor 201 or the second sensor 202 becomes temporarily invalid, to prevent the object vehicle 1 from being erroneously determined to have crossed the boundary line.

In the traveling lane matching unit 113, it is possible to perform matching processing for uniformizing: the respective determination timings of the first boundary-line calculation determination unit 101 and the second boundary-line calculation determination unit 102 at which the object vehicle 1 is determined to have crossed the boundary line; and their recognized traveling lanes on which the object vehicle 1 is traveling. As a result, there is achieved an effect of restricting the accuracy of position estimation of the object vehicle 1 from being degraded, even when the object vehicle 1 is crossing the boundary line.

### 2. Embodiment 2

<Configuration of Vehicle Position Estimation Device>

A vehicle position estimation device 100 according to Embodiment 2 corresponds to that obtained by changing the processing details of the vehicle position estimation device 100 according to Embodiment 1 through software change. With respect to the hardware, the configuration of FIG. 1 can be employed because no change is necessary.

<Matching of Distance>

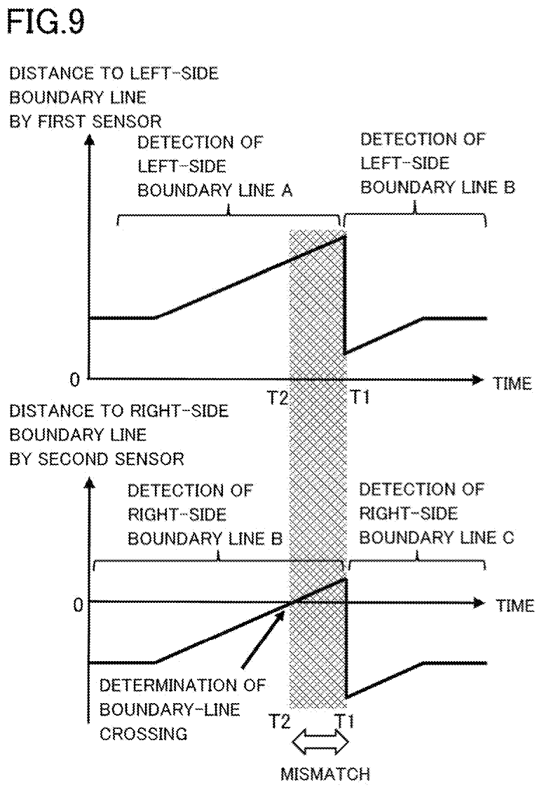

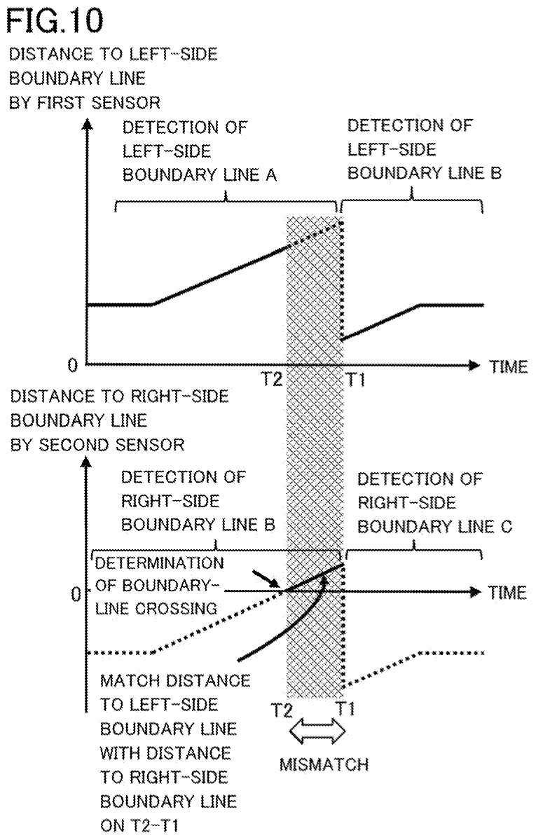

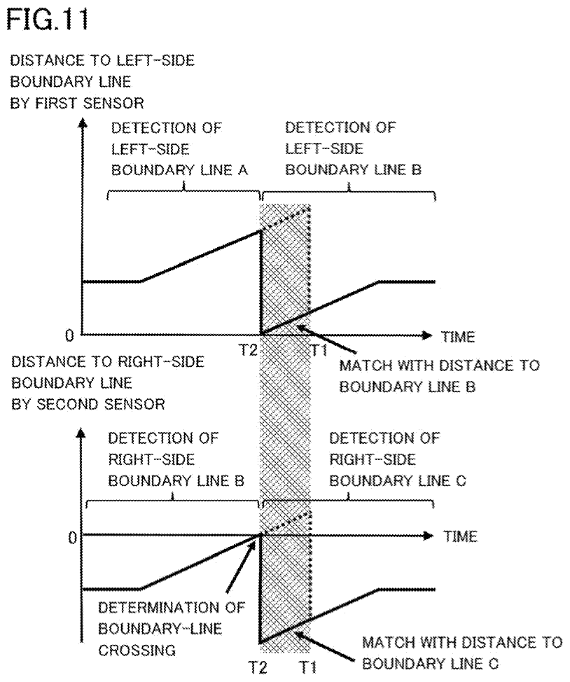

FIG. 9 is a set of graphs showing distances to boundary lines according to the first sensor 201 and the second sensor 202 during a lane change of the vehicle 1, according to Embodiment 2. FIG. 10 is a first set of graphs showing matching between the distances to the boundary lines according to the first sensor 201 and the second sensor 202 during the lane change of the vehicle 1, according to Embodiment 2. FIG. 11 is a second set of graphs showing matching between the distances to the boundary lines according to the first sensor 201 and the second sensor 202 during the lane change of the vehicle, according to Embodiment 2.

Description will be made about a case where the object vehicle 1 changes the traveling lane from the left lane to the right lane as shown in FIG. 3. The ordinate of the upper-side graph shown in FIG. 9 represents a distance to the left-side boundary line according to the first sensor 201. The ordinate of the lower-side graph shown in FIG. 9 represents a distance to the right-side boundary line according to the second sensor 202.

With respect to the distance to the left-side boundary line, a distance in the leftward direction with reference to the center line of the object vehicle 1 and relative to the traveling direction of the object vehicle 1, is regarded as positive. With respect to the distance to the right-side boundary line, a distance in the rightward direction with reference to the center line of the object vehicle 1 and relative to the traveling direction of the object vehicle 1, is regarded as negative. In the case shown in FIG. 9, because of the traveling lane change, the line nearest and left next to the object vehicle 1, is changed from the boundary line A to the boundary line B. Because of the traveling lane change, the line nearest and right next to the object vehicle 1, is changed from the boundary line B to the boundary line C.

The distance to the right-side boundary line B according to the second sensor 202 shown on the lower side in FIG. 9 reaches zero at a time T2 and thereafter, its sign is reversed. Namely, this means that, although the distance taken up to the boundary line B was a distance in the rightward direction relative to the traveling direction of the object vehicle 1, the boundary line B has moved to be located on the left side of the object vehicle 1 after the time T2.

Since the position of the boundary line is switched from right to left, the second boundary-line calculation determination unit 102 can recognize that the time T2 is the crossing time. The traveling lane matching unit 113 adjusts for matching, the distance to the left-side boundary line according to the first sensor 201, on the basis of the crossing time T2.

As shown in FIG. 10, using distances to the right-side boundary line from the time T2 to a time T1 according to the second sensor 202, the distance to the left-side boundary line according to the first sensor 201 is adjusted for matching. According to this matching, as shown in FIG. 11, the distance to the left-side boundary line according to the first sensor 201 can be matched with such data in which the distance changes abruptly at the time T1.

Further, as shown in FIG. 11, the distance to the right-side boundary line according to the second sensor 202 may also be adjusted for matching by using the distance to the boundary line C right next to the crossed boundary line B. According to this matching, the distance to the right-side boundary line according to the second sensor 202 can be matched with such data in which the distance changes abruptly at the time T2.

According to the above processing, even when the object vehicle 1 makes a traveling lane change, it is eliminated, before the input stage to the position estimation unit 114, that mutually different boundary lines are erroneously regarded as the same boundary line by the first sensor 201 and the second sensor 202. More detailed processing will be described later. Note that, in the above example, the description has been made assuming that the time T2<the time T1 (the time T2 comes earlier); however, this is not limitative. Namely, an effect similar to the above can be exhibited even when the boundary-line crossing of the object vehicle 1 is determined firstly by using the first distance according to the first sensor 201.

<Processing by Vehicle Position Estimation Device>

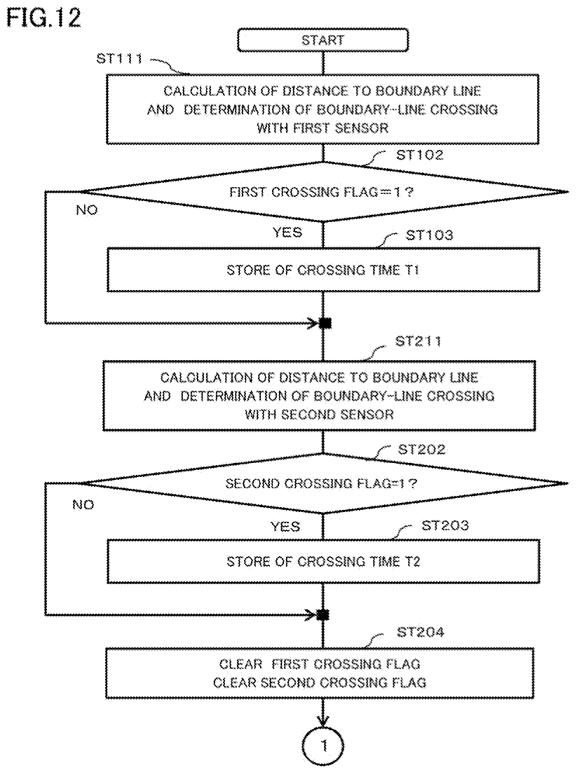

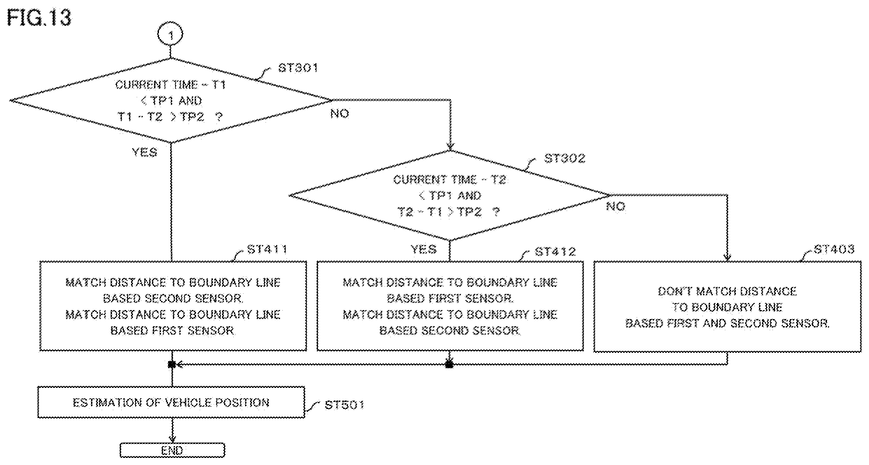

FIG. 12 is a first flowchart showing processing by the vehicle position estimation device 100 according to Embodiment 2. FIG. 13 is a second flowchart showing processing by the vehicle position estimation device 100, which shows steps subsequent to FIG. 12.

FIG. 12 and FIG. 13 are flowcharts in which shown are operations of the first boundary-line calculation determination unit 101, the second boundary-line calculation determination unit 102, the traveling lane matching unit 113 and the position estimation unit 114, from when the signals of the observed data at the current time are inputted from the respective sensors until when the estimated position of the object vehicle 1 at the current time is outputted. The processing of the flowchart of FIG. 12 is executed every fixed period of time (for example, every 10 ms). It is allowed that the processing of the flowchart of FIG. 12 is not executed every fixed period of time but executed in response to an occurrence of an event, such as, at every time the vehicle travels a fixed distance, at every time the sensor acquires new information, or at the time an instruction is given from the outside.

The flowchart of FIG. 12 according to Embodiment 2 corresponds to that obtained by changing Step ST101 and Step ST201 in the flowchart of FIG. 7 according to Embodiment 1 to Step ST111 and Step ST211. The flowchart of FIG. 13 corresponds to that obtained by changing Step ST401 and Step ST402 in the flowchart of FIG. 8 according to Embodiment 1 to Step ST411 and Step ST412. In the following, description will be made focusing on the different portions of processing.

In FIG. 12, after the processing is started, in Step ST111, the first boundary-line calculation determination unit 101 calculates the first distance between the object vehicle 1 and the boundary line on the basis of the observed data of the first sensor 201. Then, it determines whether or not the object vehicle 1 at the current time has crossed the boundary line, on the basis of the thus-calculated first distance. When it determines that the vehicle has crossed the boundary line, a first crossing flag is set.

This determination of boundary-line crossing may be made using, for example, variation in the value of the distance between the boundary line and the object vehicle 1. The occurrence of the boundary-line crossing may be determined when the first distance varies more than a predetermined crossing determination distance within a predetermined crossing determination time. Further, it is allowed to determine that the object vehicle 1 has crossed the boundary line, when the position of the boundary line is switched between right and left with respect to the object vehicle 1.

For example, the first boundary-line calculation determination unit 101 may execute calculation of a first right-side distance between the object vehicle 1 and a boundary line on the right side of the object vehicle 1, and determination based on the first right-side distance on whether or not the object vehicle 1 has crossed the boundary line on the right side thereof.

Instead, the first boundary-line calculation determination unit 101 may execute calculation of a first left-side distance between the object vehicle 1 and a boundary line on the left side of the object vehicle 1, and determination based on the first left-side distance on whether or not the object vehicle 1 has crossed the boundary line on the left side thereof. Further, instead, the first boundary-line calculation determination unit 101 may execute both of: the calculation of the first right-side distance and the determination on whether or not the object vehicle 1 has crossed the boundary line on the right side thereof; and the calculation of the first left-side distance and the determination on whether or not the object vehicle 1 has crossed the boundary line on the left side thereof.

In Step ST211, the second boundary-line calculation determination unit 102 calculates the second distance between the object vehicle 1 and the boundary line on the basis of the observed data of the second sensor 202. Then, it determines whether or not the object vehicle 1 at the current time has crossed the boundary line, on the basis of the thus-calculated second distance. When it determines that the vehicle has crossed the boundary line, a second crossing flag is set.

Like in Step ST111, the determination of boundary-line crossing in Step ST211 may also be made using, for example, variation in the value of the distance between the boundary line and the object vehicle 1. The occurrence of the boundary-line crossing may be determined when the second distance varies more than a predetermined crossing determination distance within a predetermined crossing determination time. Further, it is allowed to determine that the object vehicle 1 has crossed the boundary line, when the position of the boundary line is switched between right and left with respect to the object vehicle 1.

For example, the second boundary-line calculation determination unit 102 may execute calculation of a second right-side distance between the object vehicle 1 and a boundary line on the right side of the object vehicle 1, and determination based on the second right-side distance on whether or not the object vehicle 1 has crossed the boundary line on the right side thereof. Instead, the second boundary-line calculation determination unit 102 may execute calculation of a second left-side distance between the object vehicle 1 and a boundary line on the left side of the object vehicle 1, and determination based on the second left-side distance on whether or not the object vehicle 1 has crossed the boundary line on the left side thereof. Further, instead, the second boundary-line calculation determination unit 102 may execute both of: the calculation of the second right-side distance and the determination on whether or not the object vehicle 1 has crossed the boundary line on the right side thereof; and the calculation of the second left-side distance and the determination on whether or not the object vehicle 1 has crossed the boundary line on the left side thereof.

In Step ST411 in FIG. 13, with respect to the first distance based on the observed data of the first sensor 201 and the second distance based on the observed data of the second sensor 202, the traveling lane matching unit 113 starts adjusting the first distance and the second distance for matching, each by using a distance to a different boundary line. Specifically, it executes matching processing by using a distance to the adjacent boundary line, as described using FIG. 11. In Step ST412, with respect to the first distance based on the observed data of the sensor 201 and the second distance based on the observed data of the second sensor 202, the traveling lane matching unit 113 starts adjusting the first distance and the second distance for matching, each by using a distance to a different boundary line.

For example, in the case where one of the first boundary-line calculation determination unit 101 and the second boundary-line calculation determination unit 102 determines that the object vehicle 1 has crossed a boundary line from left to right, the traveling lane matching unit 113 may start adjusting the first right-side distance and the second right-side distance for matching, by using a distance between the object vehicle 1 and a boundary line right next to the boundary line that the object vehicle 1 has crossed. Instead, in this case, the traveling lane matching unit 113 may start adjusting the first left-side distance and the second left-side distance for matching, by using a distance between the object vehicle 1 and the boundary line that the object vehicle 1 has crossed.

Further, in the case where one of the first boundary-line calculation determination unit 101 and the second boundary-line calculation determination unit 102 determines that the object vehicle 1 has crossed a boundary line from right to left, the traveling lane matching unit 113 may start adjusting the first right-side distance and the second right-side distance for matching, by using a distance between the object vehicle 1 and the boundary line that the object vehicle 1 has crossed. Instead, in this case, the traveling lane matching unit 113 may start adjusting for matching, the first left-side distance and the second left-side distance, by using a distance between the object vehicle 1 and a boundary line left next to the boundary line that the object vehicle 1 has crossed.

By the thus-configured vehicle position estimation device 100 according to Embodiment 2, it is also possible to achieve an effect similar to that in Embodiment 1. The position estimation unit 114 estimates the position of the object vehicle 1 on the basis of the first distance and/or the second distance adjusted for matching. Accordingly, there is achieved an effect of restricting the accuracy of position estimation of the object vehicle 1 from being degraded, even when the object vehicle 1 makes a traveling lane change.

### 3. Embodiment 3

<Configuration of Vehicle Position Estimation Device>

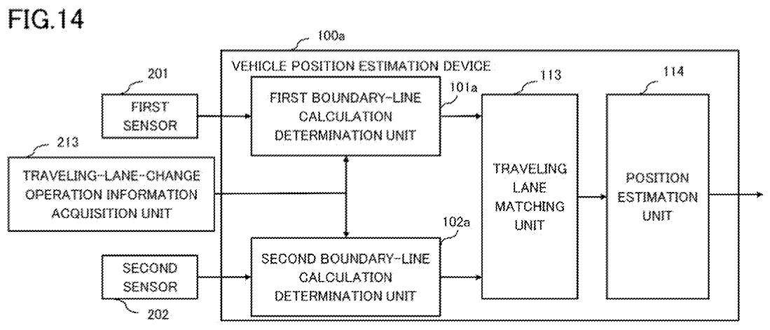

FIG. 14 is a configuration diagram of a vehicle position estimation device 100a according to Embodiment 3. The configuration diagram of FIG. 14 according to Embodiment 3 differs from the configuration diagram of the vehicle position estimation device 100 of FIG. 1 according to Embodiment 1 only in that an input signal from a traveling-lane-change operation information acquisition unit 213 is added.

In Embodiment 1, the first boundary-line calculation determination unit 101 and the second boundary-line calculation determination unit 102 are configured to determine whether or not the object vehicle has crossed a boundary line, on the basis of the signals of the first sensor 201 and the second sensor 202, respectively. However, such an error may occur in which, even though the object vehicle 1 actually makes no lane change, the vehicle is determined to have crossed the boundary line because of noise or the like in the observed data of the sensor. When such a determination error occurs, the accuracy of the estimated position of the object vehicle 1 to be outputted by the position estimation unit 114 is degraded significantly.

For that reason, in the vehicle position estimation device 100a according to Embodiment 3, the traveling-lane-change operation information acquisition unit 213 that acquires information of an operation at the time the object vehicle 1 makes a lane change is provided, and its output is used to make the determination. Examples of the information to be acquired by the traveling-lane-change operation information acquisition unit 213 may include: information about whether a winker lamp of the object vehicle 1 is lit or not; a steering angle of the object vehicle 1; a yaw rate of the object vehicle 1; biological data of the driver of the object vehicle 1; and the like. According to this configuration, it is possible to reduce the frequency of occurrence of the error in which, even though the object vehicle 1 actually makes no lane change, the vehicle is determined to have crossed a boundary line. As a result, it is possible to restrict the accuracy of position estimation of the object vehicle 1 from being degraded.

A first boundary-line calculation determination unit 101a and a second boundary-line calculation determination unit 102a use, as their inputs, the lane-change operation information outputted from the traveling-lane-change operation information acquisition unit 213. The first boundary-line calculation determination unit 101a uses, as its inputs, the observed data from the first sensor 201 and the lane-change operation information from the traveling-lane-change operation information acquisition unit 213, and then outputs to the traveling lane matching unit 113, the first distance from the object vehicle 1 to a boundary line and the determination result on whether or not the object vehicle 1 has crossed the boundary line.

The second boundary-line calculation determination unit 102a uses, as its inputs, the observed data from the second sensor 202 and the lane-change operation information from the traveling-lane-change operation information acquisition unit 213, and then outputs to the traveling lane matching unit 113, the second distance from the object vehicle 1 to a boundary line and the determination result on whether or not the object vehicle 1 has crossed the boundary line.

<Processing by Vehicle Position Estimation Device>

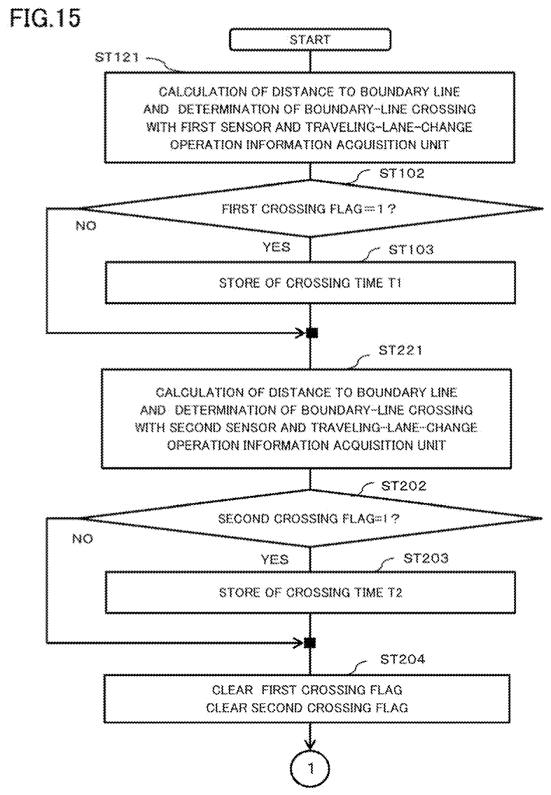

FIG. 15 is a first flowchart showing processing by the vehicle position estimation device 100a according to Embodiment 3. Processing subsequent to the flowchart of FIG. 15 is shown in FIG. 8.

FIG. 15 and FIG. 8 are flowcharts in which shown are operations of the first boundary-line calculation determination unit 101a, the second boundary-line calculation determination unit 102a, the traveling lane matching unit 113 and the position estimation unit 114, from when signals at the current time are inputted from the first sensor 201, the second sensor 202 and the traveling-lane-change operation information acquisition unit 213 until when the estimated position of the object vehicle 1 at the current time is outputted. The processing of the flowchart of FIG. 15 is executed every fixed period of time (for example, every 10 ms). It is allowed that the processing of the flowchart of FIG. 15 is not executed every fixed period of time but executed in response to an occurrence of an event, such as, at every time the vehicle travels a fixed distance, at every time the sensor acquires new information, or at the time an instruction is given from the outside.

The flowchart of FIG. 15 according to Embodiment 3 corresponds to that obtained by changing Step ST101 and Step ST201 in the flowchart of FIG. 7 according to Embodiment 1 to Step ST121 and Step ST221. In the following, description will be made focusing on the different portions of processing.

In FIG. 15, after the processing is started, in Step ST121, the first boundary-line calculation determination unit 101a calculates the first distance between the object vehicle 1 and the boundary line on the basis of the observed data of the first sensor 201. Then, it determines whether or not the object vehicle 1 at the current time has crossed the boundary line, on the basis of the thus-calculated first distance and the lane-change operation information from the traveling-lane-change operation information acquisition unit 213.

This determination of boundary-line crossing is performed using the determination method described in Embodiment 1 provided that a situation that a winker lamp is lit by the object vehicle 1, for example, is added to the conditions for determining the boundary-line crossing. That is, when the object vehicle 1 is assumed to have crossed the boundary line on the basis of the first distance and further, the winker lamp in the same direction as the crossing direction of the object vehicle 1 is lit, the object vehicle 1 is determined to have crossed the boundary line. When it is determined to have crossed the boundary line, a first crossing flag is set.

Note that, as another type of lane-change operation information, such a situation that steering by a specified angle or more is made toward the crossing direction, may be added to the conditions for determining the boundary line crossing of the object vehicle 1, by use of the steering angle sensor of the object vehicle 1. Further, when the yaw rate of the object vehicle 1 is to be used, such a situation that the absolute value of the yaw rate of the object vehicle 1 is a fixed value or more, may be added to the conditions for determining the boundary line crossing of the object vehicle 1. Further, when the biological data of the driver of the object vehicle 1 is to be used as another type of lane-change operation information, such a situation that, from the biological data, the driver of the object vehicle 1 is determined to have an intention to make a lane change, may be added to the conditions for determining the boundary line crossing of the object vehicle 1.

In Step ST221, the second boundary-line calculation determination unit 102a calculates the second distance between the object vehicle 1 and the boundary line on the basis of the observed data of the second sensor 202. Then, it determines whether or not the object vehicle 1 at the current time has crossed the boundary line, on the basis of the thus-calculated second distance and the lane-change operation information from the traveling-lane-change operation information acquisition unit 213.

Like in Step ST121, this determination of boundary-line crossing is performed by adding the situation that a winker lamp is lit by the object vehicle 1, for example, to the conditions for determining the boundary-line crossing. That is, when the object vehicle 1 is assumed to have crossed the boundary line on the basis of the second distance and further, the winker lamp in the same direction as the crossing direction of the object vehicle 1 is lit, the object vehicle 1 is determined to have crossed the boundary line. When it is determined to have crossed the boundary line, a second crossing flag is set. In addition, like in Step ST121, the other type of lane-change operation information may be used as the lane-change operation information.

By the thus-configured vehicle position estimation device 100a according to Embodiment 3, the determination of boundary-line crossing is performed using the lane-change operation information outputted from the traveling-lane-change operation information acquisition unit 213. With this configuration, it is possible to reduce the occurrence of error in which, even though the object vehicle 1 actually makes no lane change, the vehicle is determined to have crossed the boundary line because of noise or the like in the observed data of the sensor. Accordingly, there is achieved an effect of restricting the accuracy of position estimation of the object vehicle 1 from being degraded.

### 4. Embodiment 4

<Configuration of Vehicle Position Estimation Device>

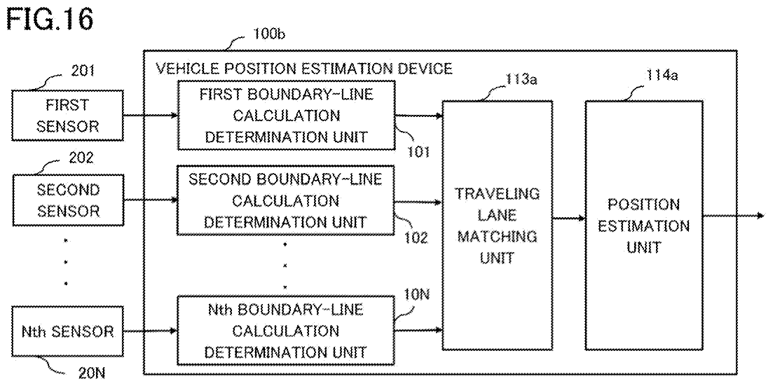

FIG. 16 is a configuration diagram of a vehicle position estimation device 100b according to Embodiment 4. In Embodiment 1, such a configuration is employed in which the position of the object vehicle 1 is estimated on the basis of the observed data of the first sensor 201 and the second sensor 202. However, there is conceivable a case where the sensor 201 and the sensor 202 both become unusable due to an internal factor in the observation environment or the device. In addition, such a case may arise where the first sensor 201 and the second sensor 202 are both degraded in observation accuracy, significantly.

For these reasons, the vehicle position estimation device 100b according to Embodiment 4 has a configuration in which the position of the object vehicle 1 is estimated on the basis of the observed data of N-number of sensors (N denotes an integer of three or more) and using N-number of boundary-line calculation determination units. With this configuration, it is possible to achieve an effect of improving tolerability to the degradation in accuracy and the failure of each of the sensors.

In FIG. 16, the observed data outputted from the Nth sensor 20N (N denotes an integer of 1 to NS) is used as the input. Here, like the first sensor 201 and the second sensor 202 described in Embodiment 1, the Nth sensor 20N may be of any type so long as it has a function of acquiring a relative positional relationship between the object vehicle 1 and a boundary line.

The Nth boundary-line calculation determination unit 10N calculates a distance to a boundary line on the basis of the observed data from the Nth sensor, and determines whether or not the object vehicle 1 has crossed the boundary line, on the basis of the thus-calculated distance. It outputs the calculated distance and the determination result to a traveling lane matching unit 113a. Further, it may add, as its input, lane-change operation information from a traveling-lane-change operation information acquisition unit 213 (not illustrated).

With respect to the respective outputs from the N-number of boundary-line calculation determination units, the traveling lane matching unit 113a makes adjusting one or more calculated distances for matching so that the respective crossing times of the object vehicle 1 are matched with each other and the respective traveling lanes on which the object vehicle 1 is traveling are matched with each other, and then it outputs the thus-adjusted distance and the distance not adjusted for matching, to a position estimation unit 114a.

Whether or not each calculated distance is to be adjusted for matching, is determined in the traveling lane matching unit 113a. With respect to the output from the traveling lane matching unit 113a, the position estimation unit 114a calculates the estimated position of the object vehicle 1 on the basis of the respective distances calculated from the observed data of the first to Nth sensors and the distance adjusted for matching.

<Processing by Vehicle Position Estimation Device>

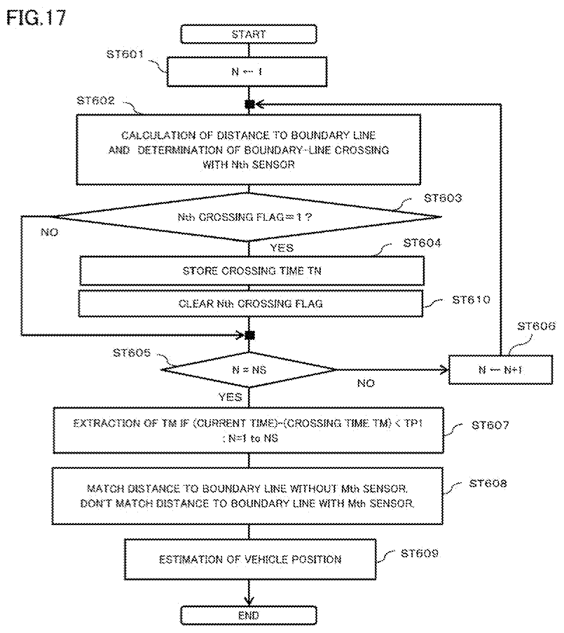

FIG. 17 is a flowchart showing processing by the vehicle position estimation device 100b according to Embodiment 4. The processing of the flowchart of FIG. 17 is executed every fixed period of time (for example, every 10 ms). It is allowed that the processing of the flowchart of FIG. 17 is not executed every fixed period of time but executed in response to an occurrence of an event, such as, at every time the vehicle travels a fixed distance, at every time the sensor acquires new information, or at the time an instruction is given from the outside.

In Step ST601 in FIG. 17, the integer N (counter N) indicative of the Nth sensor is initialized to 1. In Step ST602, the Nth boundary-line calculation determination unit 10N calculates the distance to the boundary line on the basis of the observed data of the Nth sensor 20N. Then, the Nth boundary-line calculation determination unit 10N determines whether or not the object vehicle 1 at the current time has crossed the boundary line, on the basis of the thus-calculated distance. This determination of boundary-line crossing is established by processing similar to that described at Step ST101 or Step ST201 in Embodiment 1. When it determines that the vehicle has crossed the boundary line, an Nth crossing flag is set.

In Step ST603, whether the Nth crossing flag is being set or not is determined. If it is being set (judgement is YES), the flow moves to Step ST604. If the Nth crossing flag is not being set (judgement is NO), the flow moves to Step ST605.

In Step ST604, the Nth boundary-line calculation determination unit stores a crossing time TN (N denotes an integer of 1 to NS) of the object vehicle 1 determined to have crossed the boundary line on the basis of the calculated distance. The crossing time TN is given as a value that is kept without being erased even after the completion of the entire processing of FIG. 17. Further, an observation start time of the Nth sensor is set as the initial value of TN. In Step ST610 subsequent to Step ST604, the Nth crossing flag is cleared.

In Step ST605, whether or not the integer N (counter N) indicative of an Nth order is equal to the total number NS of the sensors, is determined. If this determination is true, the loop related to the sensor N is terminated and the flow moves to Step ST607. If this determination is false, the loop is to be continued and the flow moves to Step ST606.

In Step ST606, the integer N (counter N) indicative of an Nth order is incremented by one. Thereafter, the flow moves to Step ST602, so that the calculation and the determination by the next Nth boundary-line calculation determination unit are executed.

In Step ST607, the traveling lane matching unit 113a extracts every sensor number M of the sensor with which the vehicle is already determined to have crossed the boundary line. Here, M is given as an integer not less than 1 and not more than NS. Note that the total number of extracted M may be zero or plural number. Specifically, every sensor number M of the sensor with which the difference between the current time and the crossing time TM is less than the matching duration time TP1, is extracted. The sensor number M extracted in this step will be used in the next Step ST608.

In Step St608, the traveling lane matching unit 113 executes matching processing of the distance to the boundary line based on the observed data of each of the sensors other than a sensor having the sensor number M. This makes it possible to cause the traveling lanes (on which the object vehicle 1 is traveling) based on the observed data of the sensors other than the sensor having the sensor number M, to be matched with each other. Here, the sensor number M means every sensor number M extracted in Step ST607. The matching processing of the distance is the same as the processing described at Step ST401 and Step ST402 in FIG. 8 according to Embodiment 1. The matching target distance may be set to a representative value of the distances calculated from the observed data of the sensors having the sensor number M, or a most frequent value thereof, or an average value thereof.

In Step ST609, the position estimation unit 114a estimates the position of the object vehicle 1 by using the distance calculated using the observed data of the respective sensors, and adjusted for matching or not adjusted for matching in Step ST608. This processing is the same as the processing described at Step ST501 in FIG. 8 according to Embodiment 1. For the processing by the position estimation unit 114a, an already-existing technique of sensor fusion may be employed.

Note that, in this example of FIG. 17, a case is described where the integer N is incremented one by one from 1 to NS. However, in FIG. 17, it is not necessarily required to increment (or decrement) the integer N in this manner. It suffices to design so that the integer N can take every value from 1 to NS.

By the thus-configured vehicle position estimation device 100b according to Embodiment 4, although the observed data of the N-number of sensors is used, it is possible to restrict the accuracy of position estimation of the object vehicle 1 from being degraded at the time the vehicle makes a lane change. Further, since the position of the object vehicle 1 is calculated on the basis of the observed data of the N-number sensors, there is achieved an effect of improving tolerability to the degradation in accuracy and the failure of each of the sensors.

When there is disagreement between the outputs of two sensors, namely, the first sensor 201 and the second sensor 202, and between the calculation results and determination results of the first boundary-line calculation determination unit 101 and the second boundary-line calculation determination unit 102, a case is conceivable where one of them is failed. In this occasion, a case may arise where it is difficult to determine which one of the results is to be used. Even in that case, when there are provided three or more sensors and three or more boundary-line calculation determination units, it is possible to obtain reliable calculation result and determination result by majority decision, to thereby improve the reliability of the vehicle position determination device 100b.

In this application, a variety of exemplary embodiments and examples are described; however, every characteristic, configuration or function that is described in one or more embodiments, is not limited to being applied to a specific embodiment, and may be applied singularly or in any of various combinations thereof to another embodiment. Accordingly, an infinite number of modified examples that are not exemplified here are supposed within the technical scope disclosed in the present description. For example, such cases shall be included where at least one configuration element is modified; where at least one configuration element is added or omitted; and furthermore, where at least one configuration element is extracted and combined with a configuration element of another embodiment.

What is claimed is:

1. A vehicle position estimation device, comprising:
a first boundary-line calculation determinator that detects a position of a boundary line on a road to thereby calculate a first distance between a vehicle and the boundary line, and that determines whether or not the vehicle has crossed the boundary line, on a basis of the first distance;
a second boundary-line calculation determinator that detects a position of the boundary line on the road to thereby calculate a second distance between the vehicle and the boundary line, and that determines whether or not the vehicle has crossed the boundary line, on a basis of the second distance;
a traveling lane matcher that adjusts at least one of the first distance and the second distance for matching, on a basis of: whether or not the vehicle has crossed the boundary line, determined by the first boundary-line calculation determinator; and whether or not the vehicle has crossed the boundary line, determined by the second boundary-line calculation determinator; and
a position estimator that estimates a position of the vehicle on a basis of the first distance or the second distance adjusted for matching by the traveling lane matcher.

2. The vehicle position estimation device of claim 1,
wherein the first boundary-line calculation determinator detects the position of the boundary line on a basis of a signal from a first sensor; and
wherein the second boundary-line calculation determinator detects the position of the boundary line on a basis of a signal from a second sensor.

3. The vehicle position estimation device of claim 1,
wherein the first boundary-line calculation determinator determines that the vehicle has crossed the boundary line, when the first distance varies more than a predetermined crossing determination distance within a predetermined crossing determination time or when the position of the boundary line is switched between right and left with respect to the vehicle; and
wherein the second boundary-line calculation determinator determines that the vehicle has crossed the boundary line, when the second distance varies more than the crossing determination distance within the crossing determination time or when the position of the boundary line is switched between right and left with respect to the vehicle.

4. The vehicle position estimation device of claim 1, wherein, when one of the first boundary-line calculation determinator and the second boundary-line calculation determinator determines that the vehicle has crossed the boundary line, the traveling lane matcher starts adjusting at least one of the first distance and the second distance, for matching.

5. The vehicle position estimation device of claim 4, wherein, after starting adjusting the distance for matching, the traveling lane matcher terminates said adjusting the distance after an elapse of a predetermined matching duration time.

6. The vehicle position estimation device of claim 1, wherein, when one of the first boundary-line calculation determinator and the second boundary-line calculation determinator determines, earlier than the other one of them, that the vehicle has crossed the boundary line, the traveling lane matcher starts adjusting the distance for matching so that the distance calculated by said other one of the boundary-line calculation determinators is adjusted to be equal to the distance calculated by said one of the boundary-line calculation determinators.

7. The vehicle position estimation device of claim 6, wherein, when it is determined by said other one of the boundary-line calculation determinators that the vehicle has crossed the boundary line, the traveling lane matcher terminates adjusting for matching, the distance calculated by said other one of the boundary-line calculation determinators.

8. The vehicle position estimation device of claim 1, wherein, when one of the first boundary-line calculation determinator and the second boundary-line calculation determinator determines that the vehicle has crossed the boundary line, the traveling lane matcher starts adjusting the first distance and the second distance for matching, each by using a distance to a boundary line different to said boundary line.

9. The vehicle position estimation device of claim 8,
wherein the first boundary-line calculation determinator performs at least one of: calculating as said first distance, a first right-side distance between the vehicle and the boundary line on a right side of the vehicle, followed by determining whether or not the vehicle has crossed the boundary line on the right side, on a basis of the first right-side distance; and calculating as said first distance, a first left-side distance between the vehicle and the boundary line on a left side of the vehicle, followed by determining whether or not the vehicle has crossed the boundary line on the left side, on a basis of the first left-side distance;
wherein the second boundary-line calculation determinator performs at least one of: calculating as said second distance, a second right-side distance between the vehicle and the boundary line on a right side of the vehicle, followed by determining whether or not the vehicle has crossed the boundary line on the right side, on a basis of the second right-side distance; and calculating as said second distance, a second left-side distance between the vehicle and the boundary line on a left side of the vehicle, followed by determining whether or not the vehicle has crossed the boundary line on the left side, on a basis of the second left-side distance;
wherein, when one of the first boundary-line calculation determinator and the second boundary-line calculation determinator determines that the vehicle has crossed the boundary line from left to right, the traveling lane matcher starts at least one of: adjusting the first right-side distance and the second right-side distance for matching, by using a distance between the vehicle and a boundary line located right next to the boundary line that the vehicle has crossed; and adjusting the first left-side distance and the second left-side distance for matching, by using a distance between the vehicle and the boundary line that the vehicle has crossed; and
wherein, when one of the first boundary-line calculation determinator and the second boundary-line calculation determinator determines that the vehicle has crossed the boundary line from right to left, the traveling lane matcher starts at least one of: adjusting the first right-side distance and the second right-side distance for matching, by using a distance between the vehicle and the boundary line that the vehicle has passed; and adjusting the first left-side distance and the second left-side distance by using a distance between the vehicle and a boundary line located left next to the boundary line that the vehicle has crossed.

10. The vehicle position estimation device of claim 1, further comprising a traveling-lane-change operation information acquisitor that when there is an operation for changing a traveling lane of the vehicle, acquires traveling-lane-change operation information;
wherein the first boundary-line calculation determinator determines whether or not the vehicle has crossed the boundary line, on a basis of the traveling-lane-change operation information and the first distance; and
wherein the second boundary-line calculation determinator determines whether or not the vehicle has crossed the boundary line, on a basis of the traveling-lane-change information and the second distance.

11. The vehicle position estimation device of claim 1, further comprising one or more additional boundary-line calculation determinators that each detect the position of the boundary line on the road to thereby calculate a distance between the vehicle and the boundary line, and that each determine whether or not the vehicle has crossed the boundary line, on a basis of said distance;
wherein the traveling lane matcher adjusts for matching, at least one of the first distance, the second distance and said distance calculated by the additional boundary-line calculation determinator, on a basis of: whether or not the vehicle has crossed the boundary line, determined by the first boundary-line calculation determinator; whether or not the vehicle has crossed the boundary line, determined by the second boundary-line calculation determinator; and whether or not the vehicle has crossed the boundary line, determined by the additional boundary-line calculation determinator; and
wherein the position estimator estimates the position of the vehicle on a basis of the first distance, the second distance or said distance adjusted for matching by the traveling lane matcher.
